(19) United States
(12) Patent Application Publication
(10) Pub. No.: US 2011/0308966 A1
(43) Pub. Date: Dec. 22, 2011

(54) METHOD FOR MANUFACTURING BLISKS

(75) Inventors: Arno SECHERLING, Oberursel (DE); Carsten LOOF, Frankfurt/Main (DE)

(73) Assignee: ROLLS-ROYCE DEUTSCHLAND LTD & CO KG, Blankenfelde-Mahlow (DE)

(21) Appl. No.: 13/161,615

(22) Filed: Jun. 16, 2011

(30) Foreign Application Priority Data
Jun. 17, 2010 (DE) 10 2010 024 084.2

(51) Int. Cl. B23H 5/06; C25F 3/16; B24B 1/00; C25F 3/02

(52) U.S. Cl. 205/641; 451/28

(57) ABSTRACT

A method for manufacturing a blisk for a gas turbine, in particular an aircraft gas turbine, includes generating blade profiles from an outer contour of a forged disk by milling and/or electrochemical machining. A robot-controlled, mechanical rework is performed of blade areas, in areas of the leading and trailing edges, the annulus, the fillet, the platform and the blade tip. A specified contour according to the engineering drawing of the blisk blade areas is referenced and an actual contour is determined by visualization. A difference between the specified contour and the actual contour is then calculated. The blade areas are then finish-machined and polished in a special processing machine according to a program prepared on the basis of the calculated difference.

This application claims priority to German Patent Application DE102010024084.2 filed Jun. 17, 2010, the entirety of which is incorporated by reference herein.

This invention relates to a method for the manufacture of blisks for a gas turbine, in particular an aircraft gas turbine, in which the blade profiles are generated from the outer contour of a forged disk by milling and/or electrochemical machining.

The blisks used in engine and turbine manufacture, i.e. rotor disks with integrally formed-on blades, are distinguished from conventional rotors, on which the blades are separately attached on the outer periphery, by reduced assembly effort and considerable saving of weight. As is generally known, blisks are manufactured by milling from the solid material or by electrochemical machining (ECM). In another known method, pre-manufactured blades are attached to the outer periphery of the rotor disk by friction welding.

Generation of the blades by milling or electrochemical machining however involves that the areas produced will not be equally precise and aerodynamically favorable throughout the blisk, as a consequence of which time and cost-intensive rework will be required. Milling of the blades incurs considerable time and cost investment, especially by the rework required to reduce surface roughness on the annulus, i.e. the area situated between the blades, and the fillet, i.e. the transition between blade and annulus. Moreover, the blade and blade tip area produced by milling must also be reworked with high time and cost expense.

Electrochemical machining used in blisk manufacture for generating the blades is disadvantageous in that precisely defined re-machining incurring considerable cost expense is required to provide for a process-due cusp and an elliptical shape of the blade leading and trailing edges. This means that an offset occurring in the transition area between the electrochemically produced blade and the milled or otherwise mechanically machined annulus requires removal or blending. Such processing is similarly required in the area of the blade leading and trailing edge to remove peaks or cusps and in the area of the annulus platform or, respectively, the transition area from the annulus platform to the fillet.

A broad aspect of the present inspection is to provide a cost-effective method for the manufacture of blisks which, while avoiding manual rework, allows blisk blades generated by milling and/or electrochemical machining to be finished in the area of the blade tips and the blade leading and trailing edges as well as the annulus, the fillet and the platform in accordance with the design and aerodynamic requirements specified for the component.

The present invention, in essence, provides for robot-controlled, mechanical rework of the blisk blades in the area of the leading and trailing edges, the annulus, the fillet, the blade tip and the platform on the basis of the calculated difference between the specified contour and a visualized actual contour of the respective blade areas and a rework program accordingly prepared using a controlled processing machine. The specified contour according to the engineering drawing of the blisk blades and the area situated between the blisk blades is stored in the processing machine and compared to the respective actual contour recorded by a visualization device to determine any contour differences and specifically rework the individual blade and transition areas according to a specific program based thereon. A blisk so produced is characterized in that, throughout the blisk, all blades and inter-blade areas are identical and precise in accordance with the engineering requirements. The blade leading and trailing edges will be rounded, or elliptical, also on electrochemically generated blades, with any cusps due to electrochemical processing being reliably removed in the method. Sharp edges in the blade-tip area due to milling, or steps and major surface roughness in the fillet, the annulus and the platform are eliminated, with favorable aerodynamic properties and long service life of the blisk being ultimately ensured. Costly and non-reproducible manual rework of critical rotary components is avoided.

In a further development of the present invention, visualization of the actual contour is accomplished by optical or mechanical scanning of the blisk blades. Recording of the actual contour of the blisk blades can be accomplished by, for example, a three-dimensional image produced by a camera.

For finishing the blades as well as the blade transitions and interspaces, the robot-controlled processing device provided therefore is equipped with milling and/or polishing tools.

The processing machine provided for rework is, for example, a special, robot-controlled milling machine with measuring or visualization technique integrated therein.

In the following, the present invention is more fully described by way of an exemplary embodiment: further processing of the blades generated by milling or electrochemical machining is accomplished by a robot-controlled NC process using a milling machine. Besides milling cutters, the machining tools used include polishing or similar tools. Rework of the blades in the area of the leading and trailing edge, the blade tip as well as the fillet and the annulus is performed on the basis of the specified contour stored in the milling machine and conforming to the engineering drawing and the actual contour generated by previous milling or electrochemical machining. The actual contour of the blades as well as of the fillet, the annulus and the platform, is determined by optical scanning of the blades and the inter-blade areas using a three-dimensional image produced by a camera. Subsequently, the difference between the specified contour and the actual contour so determined is calculated and the blades are milled and polished according to a program prepared on the basis of the calculated difference.

The blisks so produced—in particular also at the blade tips, the leading and trailing edges and the transitions to the annulus and the annulus as well as the platform—are made precisely to the drawing requirements and with lower surface roughness and step-free, smooth transitions and satisfy the requirements of aerodynamic properties and service life. Manual processes, i.e. processes which are inaccurate, not reproducible and anyway not acceptable on critical components, are avoided. In lieu of the expensive milling processes required for hard-to-machine materials, the lower-cost electrochemical machining can now be employed. This means that the less cost-intensive electrochemical processes are now unrestrictedly employable for blisk manufacture.

What is claimed is:

1. A method for manufacturing a blisk having a plurality of blades, comprising:
generating blade profiles from an outer contour of a forged disk by at least one of milling and electrochemical machining;
mechanically reworking, via robot control, blisk blade areas, including at least one of leading and trailing edges, an annulus, a fillet, a blade tip and a platform, with the robot control including:
referencing a stored specified contour of the blade areas according to at least one engineering drawing;
determining by visualization an actual contour of the blade areas;
calculating a difference between the specified contour and the actual contour; and
performing at least one of finish machining and polishing blade area with a processing machine according to a program prepared on a basis of the calculated difference between the specified contour and the actual contour.

2. The method of claim 1, wherein the determining by visualization of the actual contour is performed by at least one of optical and mechanical scanning of the blisk blades.

3. The method of claim 2, wherein the determining by visualization of the actual contour is performed by using a camera to produce a three-dimensional image.

4. The method of claim 3, wherein the three-dimensional image is recorded.

5. The method of claim 4, wherein the at least one of finish machining and polishing is accomplished using at least one of a milling tool, a polishing tool and a grinding tool.

6. The method of claim 1, wherein the processing machine is a robot-controlled milling machine with at least one of measuring and visualization integrated therein.

7. The method of claim 1, wherein the blade profiles are generated by milling and the at least one of finishing and polishing the blade areas is accomplished by electrochemical machining.

8. The method of claim 7, wherein the blisk is for a gas turbine.

9. The method of claim 8, wherein the blisk is for an aircraft gas turbine.

10. The method of claim 3, wherein the blisk is for a gas turbine.

11. The method of claim 10, wherein the blisk is for an aircraft gas turbine.

12. The method of claim 1, wherein the blisk is for a gas turbine.

13. The method of claim 12, wherein the blisk is for an aircraft gas turbine.
